(19) United States
(12) Patent Application Publication
(10) Pub. No.: US 2013/0262015 A1
(43) Pub. Date: Oct. 3, 2013

(54) Annotating Measurement Results Data Capture Images with Instrumentation Configuration

(71) Applicants: Travis W. L. White, Austin, TX (US); Kyle R. Bryson, Austin, TX (US); Christopher S. Ficklin, Cedar Park, TX (US)

(72) Inventors: Travis W. L. White, Austin, TX (US); Kyle R. Bryson, Austin, TX (US); Christopher S. Ficklin, Cedar Park, TX (US)

(21) Appl. No.: 13/433,471

(22) Filed: Mar. 29, 2012

(51) Int. Cl. G06F 19/00

(52) U.S. Cl. 702/108

(57) ABSTRACT

System and method for generating and using annotated measurement results data capture images. Measurement results from a first measurement system are received in response to a measurement by the first measurement system with one or more instruments. Measurement results data are displayed based on the received measurement results, and a file is stored. The file includes image data sufficient for display of the measurement results data by an image viewer, and measurement configuration data sufficient for configuring a second measurement system to repeat the measurement, where the second measurement system includes the first measurement system or another instance of the first measurement system. Subsequently, the file is received or retrieved, and one or more instruments of the second measurement system are automatically configured using the measurement configuration data to repeat the measurement.

### FIELD OF THE INVENTION

The present invention relates to the field of measurement, and more particularly to a system and method for generating and using annotated measurement results capture images.

### DESCRIPTION OF THE RELATED ART

Documenting measurement results via images of measurement data, i.e., measurement results data, e.g., waveform/measurement data screenshots, is a common practice among engineers. Many instruments, e.g., digital oscilloscopes, help with this documentation process by providing a few items of high-level instrument configuration data (e.g., voltage range, time range) directly on those images, e.g., screenshots, when they are saved to storage, e.g., on a computer, so that the waveforms can be interpreted at a later time. Different instrument vendors offer slightly different amounts of high-level configuration information and present them at slightly different locations on the image, but the implementation of the concept itself is similar across the industry.

The major shortcomings of this existing technology include the following:

1. The configuration data of the instrument that acquires the measurement results data is never complete/exhaustive. For example, oscilloscopes typically have tens of possible settings, which would overwhelm a standard screenshot image if they were exhaustively listed, i.e., all of the relevant configuration information would simply not fit on the image display. This makes it impractical to include all instrument settings on the image itself, and has presumably forced instrument vendors to include only what are deemed as “essential” settings. As a result, some configuration information which may be important for interpreting an image (for instance, AC vs. DC coupling on an oscilloscope) may not be automatically available to the engineer attempting to interpret or reproduce the measurement results data at a later time.

2. Even if the configuration information of the instrument were exhaustive (see 1 above), the instrument capturing the measurement results data (e.g., oscilloscope) is generally just one of several instruments that influence the measurement results data, e.g., waveform, produced by or related to the engineer's device under test (DUT). For instance, a power supply connected to the DUT could be either ‘on’ or ‘off’ resulting in radically different DUT waveforms. This is additional configuration information that is not automatically available to an engineer subsequently attempting to interpret or reproduce the data.

3. As a result of 1 and 2 above, interpreting and reproducing the original measurement results data (often months later, and with a modified DUT with unknown performance) using the exact same instrument settings currently involves manual documentation by the engineers, which is very difficult and tedious for engineers, and is generally prone to errors. In other words, complete certainty or reliability of measurement reproduction/replication requires manual documentation and subsequent re-configuration of both the measurement results data, e.g., waveform, capture instrument (e.g., oscilloscope) and all other instruments in the system used to make the measurements.

### SUMMARY OF THE INVENTION

Various embodiments of a system and method for annotating measurement results data capture images, and for using such annotations are presented below.

In one embodiment, measurement results may be received from a measurement system, e.g., in response to a measurement by the measurement system. The measurement may be of any phenomena desired, and may be performed using any of various types of measurement system. For example, the measurement system may include one or a plurality of instruments, which in various embodiments may be included in a single chassis or in multiple chassis. At least one of the one or more instruments may be a multi-function instrument, where a single device provides multiple functions that might otherwise be performed by respective devices, e.g., a single device that includes two or more of a signal generator, a logic analyzer, spectrum analyzer, an oscilloscope, any of various I/O capabilities, e.g., GPIO (General Purpose Input/Output), SPI (Serial Peripheral Interface), I²C (Inter-Integrated Circuit), and so forth, a power supply, or a digital multi-meter, among others. Of course, any other multi-function devices may be used as desired.

In some embodiments, the measurement system may include one or more virtual instruments (VIs), which generally have both software (e.g., a program that implements a measurement) and hardware (e.g., a computer, data acquisition (DAQ) card, sensor, etc.) components. The measurement preferably generates measurement results, e.g., waveform data, digital or analog data sets, Boolean values, etc. The measurement may be performed using a graphical program or VI (e.g., a graphical data flow program), e.g., in combination with one or more hardware devices.

Results of the measurement may be displayed via a display device in response to the received measurement results, e.g., on a display of a computer. For example, the results (i.e., measurement results) may be displayed in any of various forms or formats, including, for example, signal traces, tables of values, simple indicators, e.g., gauges, dials, charts, etc., data plots of various dimensionalities, and so forth, as desired.

A file may be stored (in a memory medium), where the file includes image data that are sufficient for display of the measurement results data by an image viewer, and measurement configuration data, which are sufficient for configuring a second measurement system to repeat the measurement. Note that in various embodiments, the second measurement system may be or include the first measurement system or another instance of the first measurement system. In a further embodiment, the second measurement system may be a different, but similar, measurement system, e.g., with one or more measurement devices that, while not identical to those of the first measurement system, may be similar enough for the configuration information to be applicable. Further details regarding the measurement configuration data are provided below.

In some embodiments, the image data can be used by any of various image viewers to display the measurement results data. Note that the types of image viewers contemplated are not limited to proprietary viewers, e.g., associated with particular measurement systems or products, but may include any programs or products that provide image viewing capabilities, even as an auxiliary feature, including, but not limited to, browsers, word processors, photo, art, or CAD (computer aided design) programs, and so forth.

Automatically storing or encrypting additional data (i.e., the measurement configuration data) inside the image file may allow users a more seamless experience for documenting their test results and also free up clutter on the viewable image. In other words, a single file—viewable on any of a wide variety of (e.g., commercial, or otherwise) image viewers—is used for the image file and also to document and carry with it the detailed information that led to the creation of the measurement data it contains. The image file may thus carry a much richer amount of information while still providing the same ease of use and substantially universal viewability to which engineers are accustomed.

In one embodiment, the measurement configuration data may include instrument configuration data for the one or more instruments of the first measurement system. The instrument configuration data may be sufficient to configure the one or more instruments of the first measurement system or a corresponding one or more instruments of the second measurement system to repeat the measurement. For example, in an exemplary case where the one or more instruments include an oscilloscope, the configuration data may include information needed to properly configure the oscilloscope (or another instance of the oscilloscope) to replicate the measurement that produced the measurement results, e.g., input coupling, sample rate, probe attenuation, input filter frequency, and possibly power supply configuration data, such as voltage level, current limit, etc., as desired or required.

In some embodiments, the first measurement system may include a graphical user interface (GUI), e.g., a soft front panel with one or more indicators for displaying the measurement results, and possibly one or more controls for receiving input. The measurement configuration data may include layout information useable to configure the GUI or a GUI of the second measurement system, e.g., to provide the same or a similar GUI for the repeat of the measurement. In embodiments where the one or more instruments include a multi-function instrument, which may also be referred to as a multi-instrument device, the multi-function instrument may have an associated multi-instrument GUI for the multi-function instrument, and the measurement configuration data may thus include layout information useable to configure the multi-instrument GUI, or a multi-instrument GUI of the second measurement system. Similarly, in some embodiments, the one or more instruments may be or include a plurality of instruments, and the plurality of instruments may have an associated multi-instrument GUI (for the plurality of instruments). The measurement configuration data may thus include layout information useable to configure the multi-instrument GUI, or a multi-instrument GUI of the second measurement system.

In one embodiment, receiving measurement results from the measurement system may include receiving raw measurement data from the measurement system. The file may then further include at least a portion of the raw measurement data. Note that these data may be different from that displayed in the GUI, although the displayed measurement results may be based on the raw data. For example, the raw measurement data may be at a different resolution than signal traces derived from the data, e.g., the raw measurement data may have been interpolated, filtered, smoothed, or otherwise processed to generate the displayed measurement data (i.e., the measurement results). Additionally, or alternatively, the raw measurement data may be in a different format from the displayed measurement, e.g., in tabular form instead of traces, etc. In some embodiments, the file further may include user annotations regarding the measurement. The annotations may include user-provided notes regarding the measurement or related aspects thereof. In one embodiment, the file may include further information, including, for example, user identification or date and time of the measurement, or ambient conditions of the measurement, e.g., temperature, humidity, local electric or magnetic fields, and so forth, as desired. As another example, the file may include an image (or multiple images) of a physical setup of the measurement system. For example, the image (or images) of the physical setup may include one or more photographs or drawings of instrument connections or cabling, e.g., a representation of the rear panel of the instrument(s), showing the connections/cables used.

Thus, additional aspects of measurement system, such as the particulars of the physical connectivity of the system, may be captured graphically, and included in the file to further communicate the details of the measurement system that produced the measurement results data.

In some embodiments, measurement configuration information such as that described above may be retrieved and used to configure a measurement system to perform a measurement similar to that from which the measurement configuration information was generated.

First, a file may be received. The file may be associated with measurement results from a measurement by a first measurement system, such as the first measurement system described above. As also described above, the file may include image data, where the image data are sufficient for display of an image of the measurement results data by an image viewer, and may further include measurement configuration data. The measurement configuration data may be sufficient for configuring a second measurement system to repeat the measurement, where, as above, the second measurement system may be or include the first measurement system or another instance of the first measurement system.

Then, one or more instruments of the second measurement system may be automatically configured using the measurement configuration data to repeat the measurement. In other words, the measurement configuration data may be retrieved from the file and used to automatically configure the second measurement system. As mentioned above, the second measurement system may be or include the first measurement system or another instance of the first measurement system. In a further embodiment, the second measurement system may be a different, but similar, measurement system, e.g., with one or more measurement devices that, while not identical to those of the first measurement system, may be similar enough for the configuration information to be applicable.

User input may be received selecting the measurement results data from a plurality of measurement results data sets, and the file may be received in response to receiving the user input selecting the measurement results data. The user input selecting the measurement results data may be received via a GUI, and may be provided in any of a variety of ways. For example, in one embodiment, the user input selecting the measurement results data includes user input selecting the image of the measurement results data from a plurality of images, e.g., from a palette of images, directory of images, menu, etc., as desired. In one embodiment, the method may include displaying at least a portion of the measurement configuration data on a display device, e.g., a computer monitor, tablet computer, etc.

As discussed above, the measurement configuration data may include instrument configuration data for the one or more instruments, where the instrument configuration data are sufficient to configure the one or more instruments to repeat the measurement. Thus, one or more instruments of the second measurement system may be automatically configured using the instrument configuration data for the one or more instruments. The instrument configuration data may include an instrument device identification (e.g., for each of the one or more instruments), and may further include a DUT (Device Under Test) version or “hardware revision”.

The second measurement system may include a graphical user interface (GUI), and the measurement configuration data may include layout information useable to configure the GUI. Accordingly, the method may further include automatically configuring the GUI based on the layout information, and displaying the GUI on a display device. Additionally, as noted above, in some embodiments, the one or more instruments may be or include a multi-function instrumentation device. The multi-function instrumentation device may have an associated multi-instrument GUI for the multi-function instrumentation device, and the measurement configuration data may include layout information useable to configure the multi-instrument GUI. The method may then include automatically configuring the multi-instrument GUI based on the layout information, and displaying the multi-instrument GUI on a display device.

Similarly, in embodiments where the one or more instruments include a plurality of instruments, the plurality of instruments may have an associated multi-instrument GUI for the plurality of instruments, and the measurement configuration data may include layout information useable to configure the multi-instrument GUI. Accordingly, the method may include automatically configuring the multi-instrument GUI based on the layout information, and displaying the multi-instrument GUI on a display device per the configuring.

As also noted above, in some embodiments, the file further includes raw measurement data from the measurement, in which case the method may further include displaying the raw measurement data on a display device. For example, displaying the raw measurement data on a display device may include displaying the raw measurement data in a GUI associated with at least one instrument of the one or more instruments. In some embodiments, this displaying may be performed while the at least one instrument is disabled or disconnected. In other words, the GUI of the (at least one) instrument may operate to display the raw measurement data when the instrument is not in use, and isn't even (currently) operable, i.e., is disabled or disconnected. Moreover, in some embodiments, the GUI may allow user interactions (possibly with the instrument still being disabled or disconnected). For example, the method may include receiving user input modifying display of the raw measurement data in the GUI. Thus, for example, the user may provide input to the GUI selecting all or some portion of the data, then filtering, culling, interpolating, or otherwise manipulating the raw measurement data. The GUI may provide more sophisticated viewing or management options of the data as well, e.g., zooming in or out of the displayed data, duplicating data sets, undo/redo functionality, etc., as desired.

Once the one or more instruments of the second measurement system have been automatically configured, the measurement may be repeated using the automatically configured one or more instruments of the second measurement system, and new measurement results data may be displayed in a graphical user interface for the second measurement system. Thus, a user may compare the original measurement to the subsequent (repeated) measurement. For example, the file may include raw measurement data from the measurement, and the repeated measurement may generate new raw data, and the method may include comparing the raw data from the measurement with the new raw data, and indicating any differences between the raw data from the measurement and the new raw data.

Similarly, in embodiments where the file further includes user annotations regarding the measurement, the method may include displaying at least a portion of the user annotations on a display device. In this manner, the user may gain improved understanding regarding any special or subtle aspects of the original measurement that a) might explain the above differences in raw data between the measurement and the new (repeated) measurement, or b) may help the user more accurately repeat the measurement. As explained above in detail, in various embodiments, the file may include any of various other items, including, for example, user identification, date and time of the measurement, ambient conditions of the measurement, an image of a physical setup of the first measurement system, at least one schematic simulation probe location, or multi-instrument probe locations (e.g., in some cases where the one or more instruments include a plurality of instruments), among others, as desired.

Thus, embodiments of a file generated based on a measurement by a first measurement system may include measurement data or information that may be used to automatically configure one or more instruments of a second measurement system to repeat the measurement. Moreover, in various further embodiments, the file may include various additional data or information that may further facilitate repetition or reproduction of the measurement, and/or may help the user understand any differences between the two measurements.

In one embodiment, the file may be used to generate a program to perform the automatic configuring of the one or more instruments. More specifically, the method may further include automatically generating a measurement application program based on the measurement configuration data. The measurement application program may then be executable by a computer system to configure the second measurement system or a third measurement system, i.e., to repeat or replicate the measurement. Once the measurement application program is generated, it may be used to automatically configure sufficiently similar measurement systems to repeat the measurement. Thus, the generated program may be sent or deployed over a network, e.g., the Internet, thereby facilitating reliable repetition or replication of measurements by other users (or may be used by the original user to easily repeat the measurement). Note, however, that due to the utility and possible benefits of the additional data or information that may be included in the file, the file may be stored or sent with the automatically generated program. Alternatively, the file may be sent or retrieved over a network, and the program generated as needed.

In some embodiments, the automatically generated program may be a graphical program, e.g., a graphical data flow program, such as a LabVIEW graphical program, although any other types of programs are also contemplated.

Thus, various embodiments of the techniques disclosed herein may facilitate replication or repeating of a prior measurement based on annotations of measurement results from the measurement.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system configured to implement an embodiment of the present invention;

FIG. 1B illustrates a network system comprising two or more computer systems that may implement an embodiment of the present invention;

FIG. 2A illustrates an instrumentation control system, according to one embodiment;

FIG. 2B illustrates an industrial automation system, according to one embodiment;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method annotating measurement results images;

FIGS. 6A and 6B illustrate a measurement results data image and annotations, respectively, according to one embodiment;

FIG. 7 illustrates measurement results data capture annotations for a multi-instrument measurement system, according to one embodiment;

FIG. 8 is a flowchart diagram illustrating one embodiment of a method for configuring measurement instruments based on annotations from measurement results data capture annotations; and

FIG. 9 illustrates configuration of a multi-instrument measurement system based on measurement results data capture annotations, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:
U.S. Pat. No. 4,914,568 titled “Graphical System for Modeling a Process and Associated Method,” issued on Apr. 3, 1990.
U.S. Pat. No. 5,481,741 titled “Method and Apparatus for Providing Attribute Nodes in a Graphical Data Flow Environment”.
U.S. Pat. No. 6,173,438 titled “Embedded Graphical Programming System” filed Aug. 18, 1997.
U.S. Pat. No. 6,219,628 titled “System and Method for Configuring an Instrument to Perform Measurement Functions Utilizing Conversion of Graphical Programs into Hardware Implementations,” filed Aug. 18, 1997.
U.S. Pat. No. 7,210,117 titled “System and Method for Programmatically Generating a Graphical Program in Response to Program Information,” filed Dec. 20, 2000.

### TERMS

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Graphical Program—A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program—A Software Program in which the program architecture is that of a directed graph specifying the flow of data through the program, and thus functions execute whenever the necessary input data are available. Data flow programs can be contrasted with procedural programs, which specify an execution flow of computations to be performed. As used herein “data flow” or “data flow programs” refer to “dynamically-scheduled data flow” and/or “statically-defined data flow”.

Graphical Data Flow Program (or Graphical Data Flow Diagram)—A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW VI is one example of a graphical data flow program. A Simulink block diagram is another example of a graphical data flow program.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Measurement Results Data—refers to data resulting from one or more measurements. Thus, “measurement results data capture image”, or “measurement results capture image”, or simply “measurement results image”, refers to an image that captures measurement results (data), such as a screenshot of measurement waveform data, e.g., that may be generated by or for a GUI of a computer controlled or implemented measurement device/instrument. Other variants may also apply, e.g., “measurement data image”, “measurement capture image”, and so forth.

The term “measurement data” may at times be used to specifically refer to measurement results data, or, to refer to any kind of data associated with measurement, which may include requirements or configuration data, etc. Generally, the context of use will indicate which of these meanings is intended.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

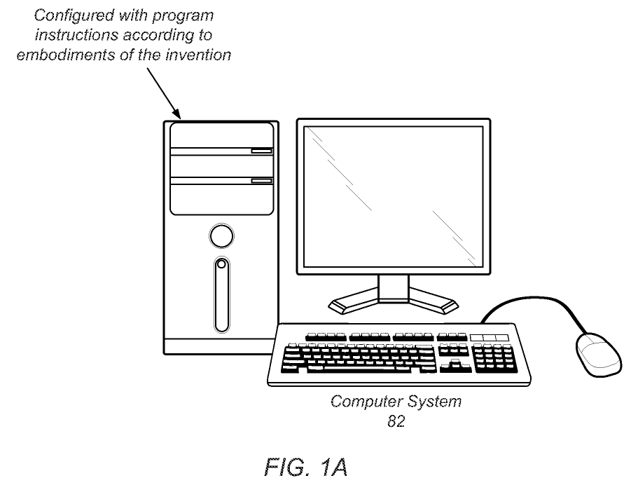

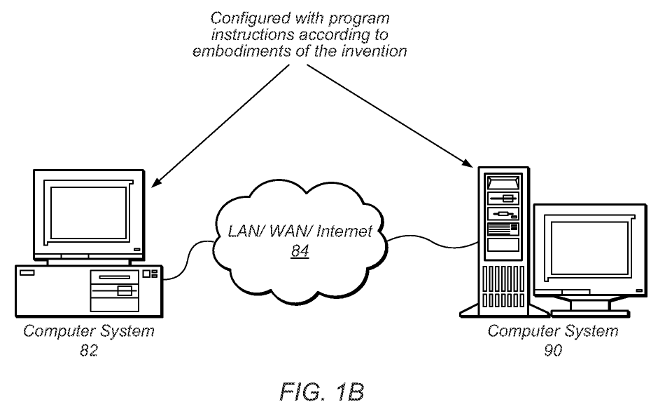

### FIG. 1A—Computer System

FIG. 1A illustrates a computer system 82 configured to implement embodiments of the present invention. Embodiments of methods for annotating measurement results capture images and for using such annotations are described below.

As shown in FIG. 1A, the computer system 82 may include a display device configured to display measurement results as, or after, the measurement is performed. The display device may also be configured to display a graphical user interface or front panel of an instrument used to perform the measurement. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more programs, e.g., graphical programs, which are executable to perform the methods described herein. Additionally, the memory medium may store a programming development environment application, e.g., a graphical programming development environment application, such as the LabVIEW graphical program development environment provided by National Instruments Corporation, used to create and/or execute such programs. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a virtual instrument (VI), e.g., a graphical program, in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system. Of course, the above distributed functionality may also be applied to text-based programs.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the program may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

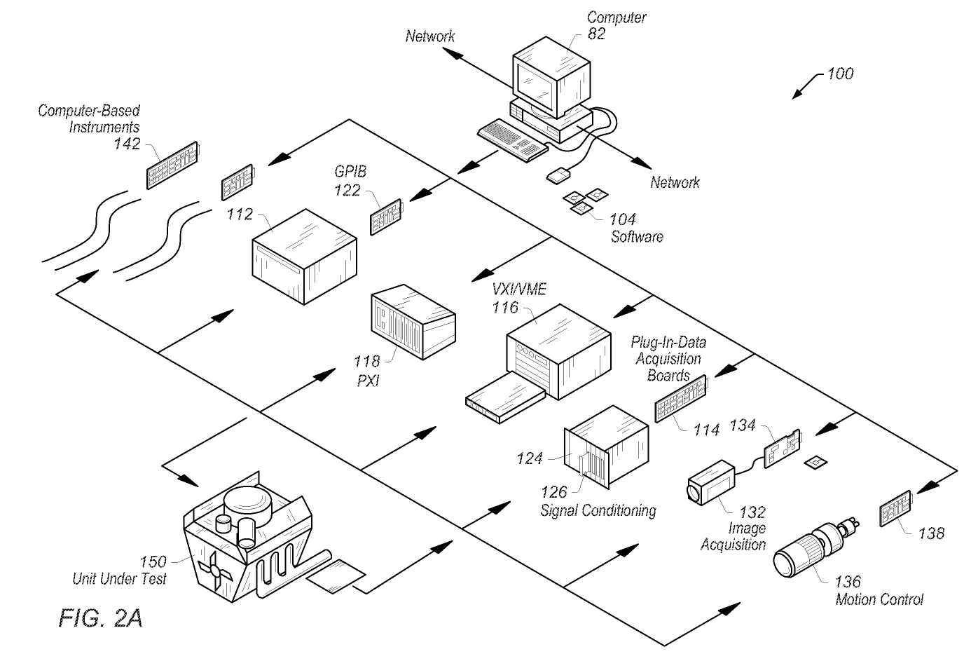

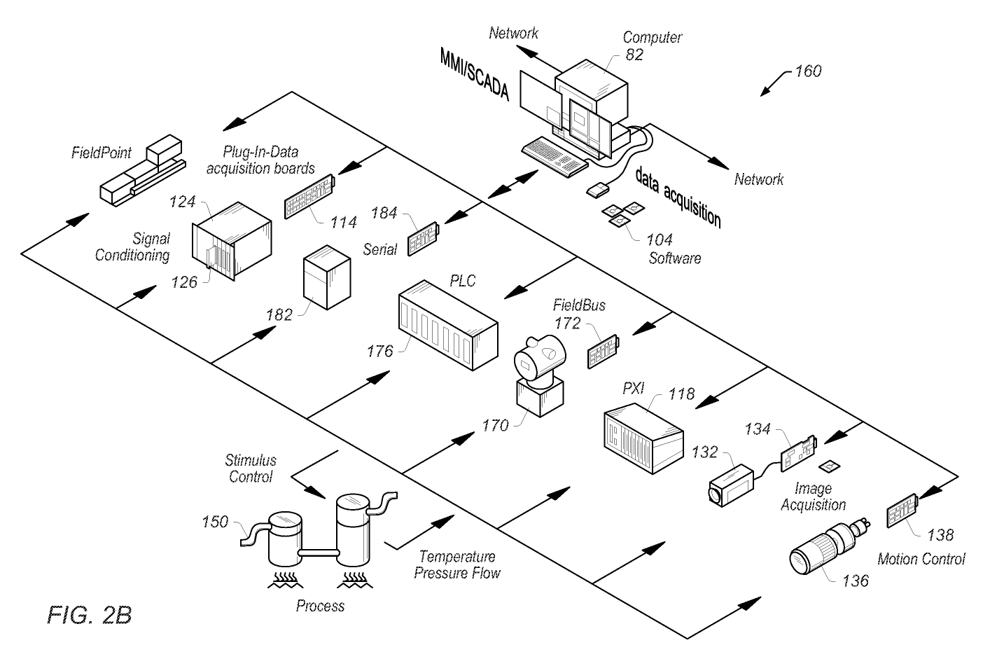

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to perform an automation function with respect to a process or device 150, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

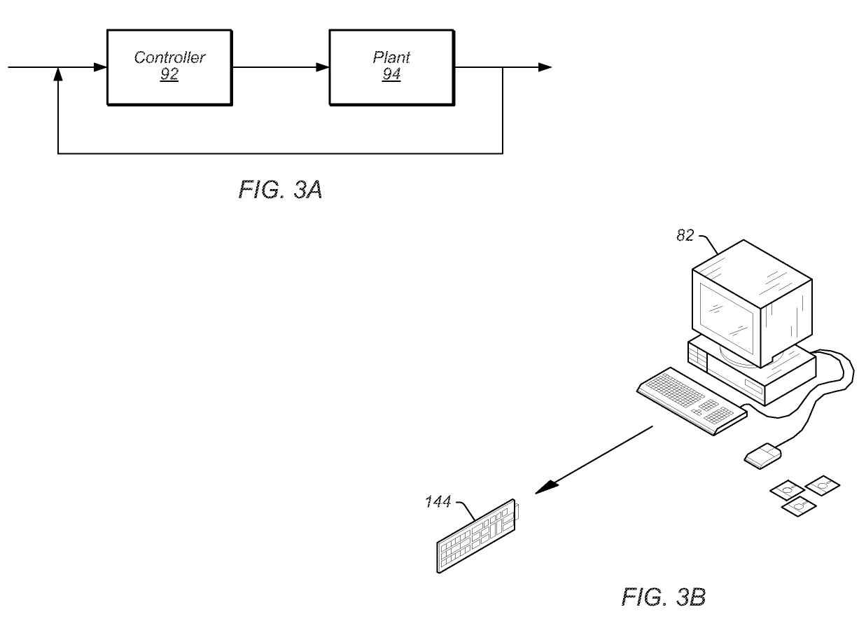

FIG. 3A is a high level block diagram of an exemplary system which may execute or utilize graphical programs (or text-based programs). FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical or textual program that specifies or implements the functionality of one or both of the controller 92 and the plant 94. For example, a control engineer may use a modeling and simulation tool to create a model (e.g., the graphical program) of the plant 94 and/or to create the algorithm (e.g., the graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical (or textual) program or model, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical (or textual) program, and the graphical (or textual) program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical (or textual) programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical (or textual) program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a program. Thus the user may create a graphical (or textual) program on a computer and use (execute) the graphical (or textual) program on that computer or deploy the graphical (or textual) program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

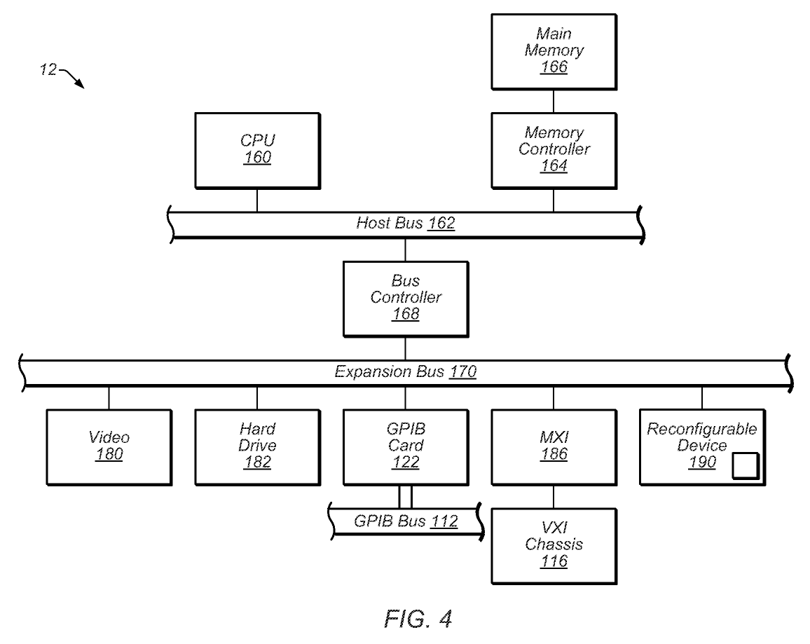

### FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store program instructions implementing embodiments of the present invention. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170. The computer 82 may also comprise a GPIB card 122 coupled to a GPIB bus 112, and/or an MXI device 186 coupled to a VXI chassis 116.

As shown, a device 190 may also be connected to the computer. The device 190 may include a processor and memory which may execute a real time operating system. The device 190 may also or instead comprise a programmable hardware element. The computer system may be configured to deploy a graphical (or textual) program to the device 190 for execution of the program on the device 190. In embodiments using a graphical program, the deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

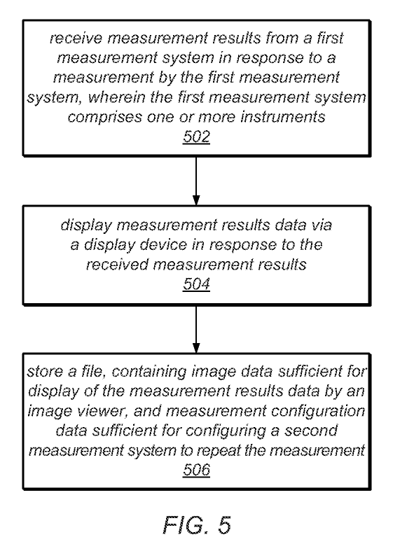

### FIG. 5—Flowchart of a Method for Annotating Measurement Results Data Capture Images

FIG. 5 illustrates a method for automatically annotating measurement results data capture images. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 502, measurement results may be received from a measurement system, e.g., in response to a measurement by the measurement system. The measurement may be of any phenomena desired, and may be performed using any of various types of measurement system. For example, the measurement system may include one or more instruments, such as, but not limited to, any of the instruments or devices discussed above. In one embodiment, the measurement may be performed using multiple instruments, which in various embodiments may be included in a single chassis or in multiple chassis. In one exemplary embodiment, at least one of the one or more instruments may be a multi-function instrument, where a single device provides multiple functions that might otherwise be performed by respective devices. One exemplary multi-function instrument or device is a single device that includes two or more of a signal generator, a logic analyzer, a spectrum analyzer, an oscilloscope, any of various I/O capabilities, e.g., GPIO (General Purpose Input/Output), SPI (Serial Peripheral Interface), I²C (Inter-Integrated Circuit), and so forth, a power supply, or a digital multi-meter, among others. Of course, any other multi-function devices may be used as desired.

As noted above, in some embodiments, the measurement system may include one or more virtual instruments (VIs), which generally have both software (e.g., a graphical program) and hardware (e.g., a computer, data acquisition (DAQ) card, sensor, etc.) components. The measurement preferably generates measurement results, e.g., waveform data, digital or analog data sets, Boolean values, etc.

In some embodiments, the measurement may be performed using a graphical program or VI, e.g., in combination with one or more hardware devices. The graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. As noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program.

In an alternate embodiment, the graphical program may be created by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function that is desired to be performed by the instrument (s).

In 504, results of the measurement of 502 may be displayed via a display device in response to the received measurement results, e.g., on a display of a computer. For example, in various embodiments, the results (i.e., measurement results) may be displayed in any of various forms or formats, including, for example, signal traces, tables of values, simple indicators, e.g., gauges, dials, charts, etc., data plots of various dimensionalities, and so forth, as desired.

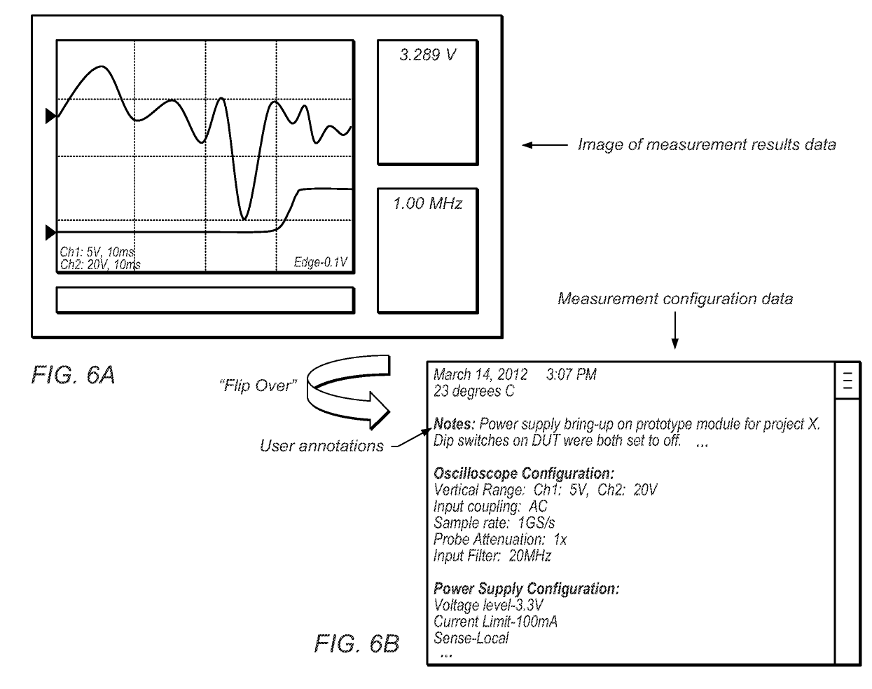

One example of an image of such measurement results data is shown in FIG. 6A, in which two signal traces (channels 1 and 2, respectively) from an oscilloscope are displayed, along with limited configuration data for the oscilloscope channels, specifically “Ch1: 5V, 10 ms”, and “Ch2: 20 V, 10 ms”. Limited configuration data for other aspects of the measurement system are also shown in the two boxes on the right of the display, e.g., a voltage reading (3.289V), e.g., from a digital multi-meter (DMM), and a frequency (1.00 MHz) of a signal generator. Note, however, that other important aspects of the measurement system configuration are not included in the display, e.g., input coupling, sample rate, probe attenuation, input filter frequency, as well as other important related configuration data for the power supply used.

In 506, a file may be stored (in a memory medium), where the file includes image data that are sufficient for display of the measurement results data by an image viewer, and measurement configuration data, which are sufficient for configuring a second measurement system to repeat the measurement. In some embodiments, the file (or a portion thereof) may be encrypted. For example, in one embodiment, the measurement configuration data may be encrypted inside the image data.

Note that in various embodiments, the second measurement system may be or include the first measurement system or another instance of the first measurement system. In a further embodiment, the second measurement system may be a different, but similar, measurement system, e.g., with one or more measurement devices that, while not identical to those of the first measurement system, may be similar enough for the configuration information to be applicable. Further details regarding the measurement configuration data are provided below.

In some embodiments, the image data can be used by any of various image viewers to display the measurement results data. Note that the types of image viewers contemplated are not limited to proprietary viewers, e.g., associated with particular measurement systems or products, but may include any programs or products that provide image viewing capabilities, even as an auxiliary feature, including, but not limited to, browsers, word processors, photo, art, or CAD (computer aided design) programs, and so forth.

Automatically storing or encrypting additional data (i.e., the measurement configuration data) inside the image file may allow users a more seamless experience for documenting their test results and also free up clutter on the viewable image. In other words, a single file—viewable on any of a wide variety of (e.g., commercial, or otherwise) image viewers—to also document and carry with it the detailed information that led to the creation of the measurement data it contains. The image file may thus carry a much richer amount of information while still providing the same ease of use and substantially universal viewability to which engineers are accustomed.

In one embodiment, the measurement configuration data may include instrument configuration data for the one or more instruments of the first measurement system. The instrument configuration data may be sufficient to configure the one or more instruments of the first measurement system or a corresponding one or more instruments of the second measurement system to repeat the measurement. For example, following the exemplary case of the oscilloscope of FIG. 6A, the configuration data may include information needed to properly configure the oscilloscope (or another instance of the oscilloscope) to replicate the measurement that produced the measurement results of 504 (displayed in FIG. 6A), e.g., the above mentioned input coupling, sample rate, probe attenuation, input filter frequency, and possibly power supply configuration data, such as voltage level, current limit, etc., as desired or required.

When designing products, engineers will often need to test and compare multiple revisions of their designs as they systematically fix bugs in those designs (often over the course of many months). In other words, engineers may receive a “revision B” of their design many months after their “revision A”, making it very difficult to exactly replicate their measurements from “revision A” (without our suggested improvements). Similarly, there may be different versions of the instruments used in the measurement. Thus, in one embodiment, the instrument configuration data may include an instrument device identification (instrument device ID), or a DUT (Device Under Test) version, sometimes referred to in the art as the “hardware revision” of the DUT. Alternatively, this information may be considered to be annotations, discussed further below.

In some embodiments, the first measurement system may include a graphical user interface (GUI), e.g., a soft front panel with one or more indicators for displaying the measurement results, and possibly one or more controls for receiving input. The measurement configuration data may include layout information useable to configure the GUI or a GUI of the second measurement system, e.g., to provide the same or a similar GUI for the repeat of the measurement.

In one exemplary embodiment, the one or more instruments may include a multi-function instrument, which may also be referred to as a multi-instrument device. In other words, at least one of the one or more instruments may be a device that provides functionality of multiple instruments that might normally be separate devices. Accordingly, the multi-function instrument may have an associated multi-instrument GUI for the multi-function instrument, and the measurement configuration data may thus include layout information useable to configure the multi-instrument GUI, or a multi-instrument GUI of the second measurement system.

Similarly, in some embodiments, the one or more instruments may be or include a plurality of instruments, and the plurality of instruments may have an associated multi-instrument GUI (for the plurality of instruments). The measurement configuration data may thus include layout information useable to configure the multi-instrument GUI, or a multi-instrument GUI of the second measurement system.

In one embodiment, receiving measurement results from the measurement system (see 502 above) may include receiving raw measurement data from the measurement system. The file may further include at least a portion of the raw measurement data. Note that these data may be different from that displayed in the GUI, although the displayed measurement results may be based on the raw data. For example, the raw measurement data may be at a different resolution than signal traces derived form the data, e.g., the raw measurement data may have been interpolated, filtered, smoothed, or otherwise processed to generate the displayed measurement data (i.e., the measurement results). Additionally, or alternatively, the raw measurement data may be in a different format from the displayed measurement, e.g., in tabular form instead of traces, etc.

In some embodiments, the file further may include user annotations regarding the measurement. The user annotations may include user-provided notes regarding the measurement or related aspects thereof, an example of which is provided in FIG. 6B, described below.

In one embodiment, the file may include further information, including, for example, user identification or date and time of the measurement, or ambient conditions of the measurement, e.g., temperature, humidity, local electric or magnetic fields, and so forth, as desired. As another example, the file may include an image (or multiple images) of a physical setup of the measurement system. For example, the image (or images) of the physical setup may include one or more photographs or drawings of instrument connections or cabling, e.g., a representation of the rear panel of the instrument(s), showing the connections/cables used.

Thus, additional aspects of measurement system, such as the particulars of the physical connectivity of the system, may be captured graphically, and included in the file to further communicate the details of the measurement system that produced the measurement results data.

Other aspects of the measurement or measurement system may also be included. For example, the file may also include at least one schematic simulation probe location, or in cases where the one or more instruments include a plurality of instruments, multi-instrument probe locations.

In some embodiments, e.g., after the file has been stored (in 506 above), an image may be displayed in a GUI based on the image data. For example, a user associated with the original measurement, or a different user, may invoke display of the image to view results of the measurement. The image may be or include a screenshot of the measurement results data, e.g., similar to the display of FIG. 6A, described above.

User input may be received to the GUI invoking display of the measurement configuration data, and the measurement configuration data may be displayed in response to the user input to the GUI. For example, receiving user input to the GUI may include receiving user input “flipping” the image, and displaying the measurement configuration data may include displaying the measurement configuration data in a manner suggestive that the measurement configuration data are displayed on the back of the image. In other words, much like viewing a data/caption written on the back of a paper photograph, users, e.g., engineers, may be able to “flip over” a measurement results capture image (e.g., of a waveform) to view a list of instrument settings used to generate the results. This would provide engineers very useful information during the analysis of the data at a later time, in comparison to prior art approaches where engineers must store this data manually (if desired), which as a result is often overlooked. Additionally, the ability to put this information on “the back” of an image also removes cluttered text from the image itself. Furthermore, as discussed below, regarding multifunction instrument (or multi-device hardware), in some embodiments, the (“back” of the) screenshot may include not only configuration settings from the instrument that generated the display, e.g., the waveform capture instrument (oscilloscope), but may also include information from other instruments/functions as well, providing even more context about the system configuration used when the data were produced. Note, however, that in some embodiments, this feature may require dedicated viewing software on the computer (e.g., personal computer, workstation, or tablet), and in one exemplary embodiment, may be integrated into the GUI, e.g., the “Soft Front Panel” (SFP) of the instrument itself.

FIG. 6B illustrates an exemplary embodiment where the user input “flips” the measurement results image over to display corresponding measurement configuration data, as indicated by the twisted arrow between FIGS. 6A and 6B. The user input may be in the form of a gesture, e.g., a “swipe” made with a mouse or touchpad/touch-screen, a menu selection, or any other means, as desired. Moreover, in some embodiments, the “flipping” may be graphically indicated via an animation, e.g., where the image of the measurement results is shown flipping over to reveal the “back” of the display, whereby the measurement configuration data are presented. Of course, other visual metaphors or transitions may be used as desired, e.g., instantly replacing the results image with the configuration data image, fading from one to the other, etc. Note that in the embodiment shown, a slider bar is included for viewing (scrolling through) long lists of data.

As may be seen, in the exemplary embodiment of FIG. 6B, the measurement configuration data include instrument (e.g., oscilloscope) configuration information such as the vertical voltage ranges for each channel (also shown in FIG. 6A), input coupling (“AC”), sample rate (“1 GS/s”), probe attenuation (“1×”), and input filter frequency (“20 MHz”). In this exemplary embodiment, power supply configuration data are also provided, specifically, voltage level (“3.3V”), current limit (“100 mA”), and so forth. Note that this example also includes data (“Mar. 14, 2012”), time (“3:07 PM”), and ambient temperature (“23 degrees C”), as well as exemplary user annotations: “Power supply bring-up on prototype module for project X. Dip switches on DUT were both set to off.”

As noted above, in some embodiments, the one or more instruments may be or include a plurality of instruments, or a multi-instrument device (also referred to as a multi-function instrument), and may have an associated multi-instrument GUI (for the plurality of instruments, or the multi-instrument device (or multi-function device), and the measurement configuration data may thus include layout information for configuring the multi-instrument GUI, or a multi-instrument GUI of the second measurement system.

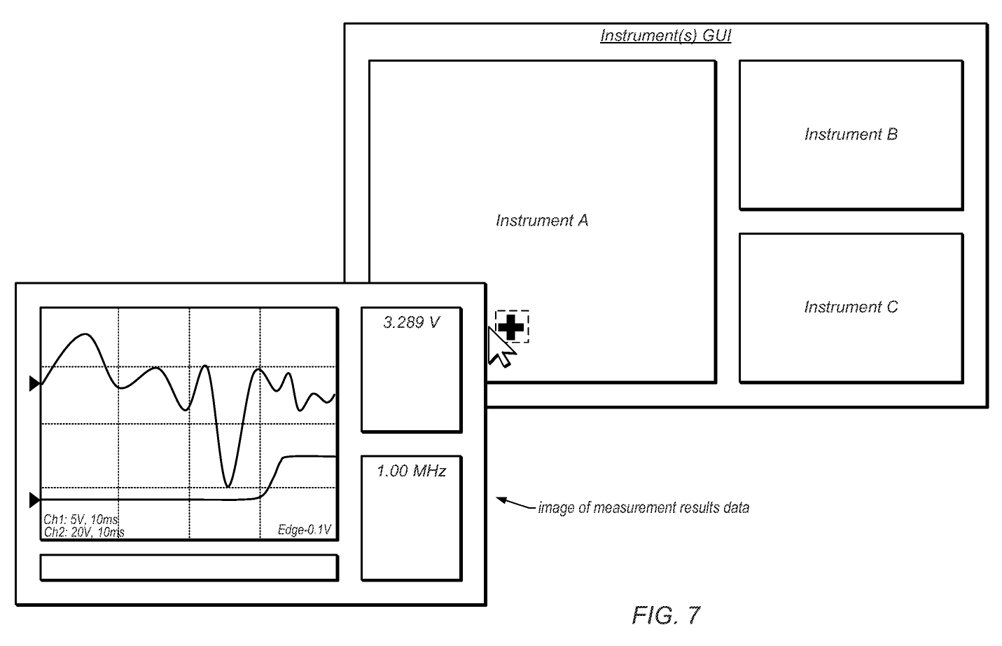

FIG. 7 illustrates an exemplary display (in a GUI) of measurement results data (similar to that of FIG. 6A) as well as a multi-instrument GUI, e.g., soft front panel, partitioned per instrument (or function). More specifically, in the embodiment shown, there are three different instruments, A, B, and C, involved in the measurement, each with a respective GUI or GUI portion (e.g., soft front panel) that may be configured per the saved measurement configuration data (specifically that portion that specifies the GUI layout for each instrument GUI or GUI portion. The user may invoke configuration (and/or display) of the multi-instrument GUI via any of a variety of ways. In one exemplary embodiment, illustrated in FIG. 7, the user may drag and drop the displayed image of measurement results data onto the GUI (or a template for the GUI) to invoke configuration and/or display of the GUI based on the layout information. Thus, in this embodiment, an instrument screenshot (with associated measurement configuration data) may be used to automatically restore the settings used during its capture to configure the GUI (e.g., soft front panel). Note that while the embodiment shown assumes “dragging” the screenshot via a mouse, e.g., in a Windows™ environment, any other techniques may be used as desired, e.g., a right-click menu selection, “touch to select” on a tablet or touch-screen, touch-pad, etc.

In this particular embodiment, the three main windows of the measurement results data correspond respectively to the three portions (e.g., instrument GUIs) of the multi-instrument GUI of FIG. 7, where instrument A is an oscilloscope, instrument B is a digital multi-meter (DMM), and instrument C is a signal generator. Accordingly, upon dropping the image of measurement results data onto the multi-instrument GUI, configuration information for each instrument may be displayed in the appropriate respective GUI or GUI portion.

Thus, in addition to automatically storing and allowing users (e.g., engineers) to review configuration data from (multiple) instruments at a later time, in some embodiments, these same instrument settings may be automatically reloaded onto the hardware by referencing that instrument screenshot (or more generally, measurement results data). In other words, an engineer may select the screenshot (or other results) that they would like to reproduce (possibly through dragging the image onto the instrument SFP) and the instrument settings used to take that screenshot may automatically be reapplied. This is in direct contrast with prior art approaches that can take engineers tens of minutes to locate and apply old settings—especially if settings need to be applied to multiple instruments in the system, and where, as a result of the time required to apply old settings, engineers often attempt to quickly apply only the most important settings from their memory, which is often prone to mistakes which, if not caught quickly, can lead to hours or even days of confusion. Thus, since reproducing data many months after an original measurement is a common task for many engineers, the techniques disclosed herein may drastically reduce the time and uncertainty associated with that task.

In one embodiment, the file may be useable to automatically generate a measurement application program executable by a computer system to configure the first measurement system or another instance of the first measurement system. In other words, based on the information stored in the file, a program may be automatically generated that is executable to configure the first measurement system or another instance of the measurement system (or a second, similar, measurement system). In one embodiments, the measurement application may be a graphical measurement application program, e.g., a graphical data flow program, such as a LabVIEW graphical program, although other types of programs may be generated as desired.

### Configuration of a Measurement System

In some embodiments, measurement configuration information such as that described above may be retrieved and used to configure a measurement system to perform a measurement similar to that from which the measurement configuration information was generated.

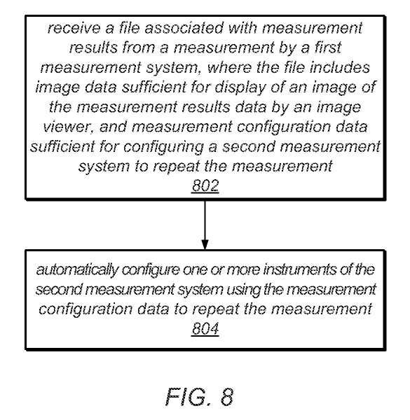

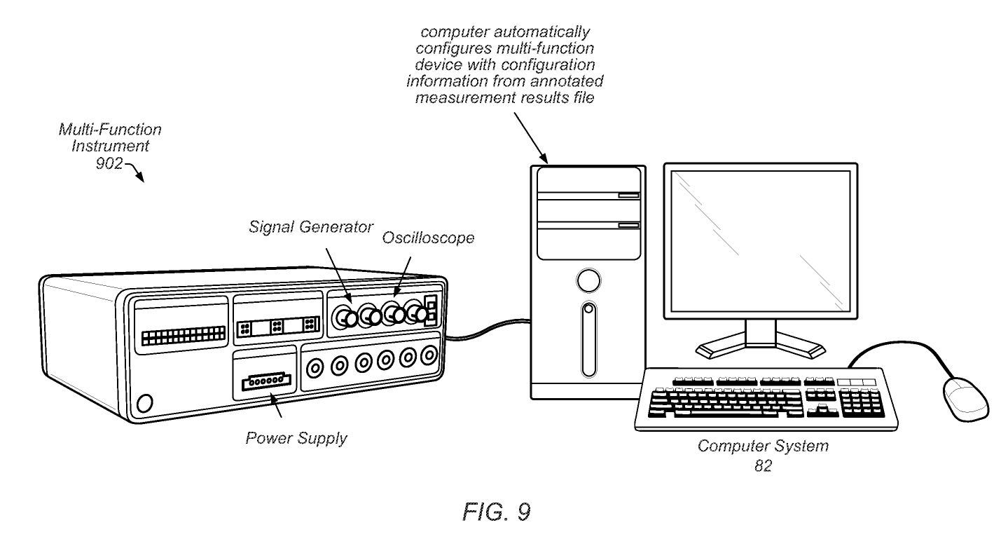

FIG. 8 illustrates a method for automatically configuring a measurement system based on annotated measurement results data capture images. The method shown in FIG. 8 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 802, a file may be received. The file may be associated with measurement results from a measurement by a first measurement system, such as the first measurement system described above. As also described above, in some embodiments, the file may include image data, where the image data are sufficient for display of an image of the measurement results data by an image viewer, and may further include measurement configuration data. The measurement configuration data may be sufficient for configuring a second measurement system to repeat the measurement, where, as above, the second measurement system may be or include the first measurement system or another instance of the first measurement system.

Then, in 804, one or more instruments of the second measurement system may be automatically configured using the measurement configuration data to repeat the measurement. In other words, the measurement configuration data may be retrieved from the file and used to automatically configure the second measurement system. As mentioned above, the second measurement system may be or include the first measurement system or another instance of the first measurement system. In a further embodiment, the second measurement system may be a different, but similar, measurement system, e.g., with one or more measurement devices that, while not identical to those of the first measurement system, may be similar enough for the configuration information to be applicable.

In one embodiment, user input may be received selecting the measurement results data from a plurality of measurement results data sets, and the file (of 802) may be received in response to receiving the user input selecting the measurement results data. The user input selecting the measurement results data may be received via a GUI, and may be provided in any of a variety of ways. For example, in one embodiment, the user input selecting the measurement results data includes user input selecting the image of the measurement results data from a plurality of images, e.g., from a palette of images, directory of images, menu, etc., as desired.

In one embodiment, the method may include displaying at least a portion of the measurement configuration data on a display device, e.g., a computer monitor, tablet computer, etc.

As discussed above with reference to the method of FIG. 5, the measurement configuration data may include instrument configuration data for the one or more instruments, where the instrument configuration data are sufficient to configure the one or more instruments to repeat the measurement. Thus, one or more instruments of the second measurement system may be automatically configured using the instrument configuration data for the one or more instruments. The instrument configuration data may include an instrument device identification (e.g., for each of the one or more instruments), and may further include a DUT (Device Under Test) version or “hardware revision”.

The second measurement system may include a graphical user interface (GUI), and the measurement configuration data may include layout information useable to configure the GUI. Accordingly, the method may further include automatically configuring the GUI based on the layout information, and displaying the GUI on a display device. Additionally, as noted above, in some embodiments, the one or more instruments may be or include a multi-function instrumentation device. The multi-function instrumentation device may have an associated multi-instrument GUI for the multi-function instrumentation device, and the measurement configuration data may include layout information useable to configure the multi-instrument GUI. The method may then include automatically configuring the multi-instrument GUI based on the layout information, and displaying the multi-instrument GUI on a display device.

FIG. 9 illustrates configuration of a multi-instrument measurement system based on measurement results data capture annotations, according to one embodiment. As may be seen, an exemplary multi-function instrument 902 is shown coupled to a computer, e.g., computer system 82. The exemplary multi-function instrument includes various functions or modules implemented within a single device (or chassis), including a signal generator, an oscilloscope, and a power supply, although in other embodiments, different sets of functions may be used as desired. Other exemplary functions that may be included in various embodiments of the multi-function instrument include, but are not limited to, spectrum analyzer, logic analyzer, digital I/O, digital multi-meter (DMM), and source measure unit, among others. Note that in various embodiments, any two or more functions may be implemented in the instrument as desired.

As indicated, the computer system 82 may automatically configure some or all of the various functions or modules of the multi-function instrument based on a stored file as described herein. Note that the configuration may include configuring a GUI for the device (e.g., that may execute and/or be displayed on the computer 82) based on layout information.

Similarly, in embodiments where the one or more instruments include a plurality of instruments, the plurality of instruments may have an associated multi-instrument GUI for the plurality of instruments, and the measurement configuration data may include layout information useable to configure the multi-instrument GUI. Accordingly, the method may include automatically configuring the multi-instrument GUI based on the layout information, and displaying the multi-instrument GUI on a display device per the configuring.

As also noted above, in some embodiments, the file further includes raw measurement data from the measurement, in which case the method may further include displaying the raw measurement data on a display device. For example, displaying the raw measurement data on a display device may include displaying the raw measurement data in a GUI associated with at least one instrument of the one or more instruments. In some embodiments, this displaying may be performed while the at least one instrument is disabled or disconnected. In other words, the GUI of the (at least one) instrument may operate to display the raw measurement data when the instrument is not in use, and isn't even (currently) operable, i.e., is disabled or disconnected. Moreover, in some embodiments, the GUI may allow user interactions (possibly with the instrument still being disabled or disconnected). For example, the method may include receiving user input modifying display of the raw measurement data in the GUI. Thus, for example, the user may provide input to the GUI selecting all or some portion of the data, then filtering, culling, interpolating, or otherwise manipulating the raw measurement data. The GUI may provide more sophisticated viewing, analysis, or management operations on or of the raw data as well, e.g., using “graph cursors” to mark, specify, or delineate portions of the raw data for processing, e.g., for zooming in or out on the displayed data, duplicating data sets, undo/redo functionality, filtering or otherwise processing selected data, etc., as desired. Thus, in response to user input to the GUI, the method may perform one or more interactive analysis tasks on the raw data using any tools built into or invocable by the GUI.

Once the one or more instruments of the second measurement system have been automatically configured, the measurement may be repeated using the automatically configured one or more instruments of the second measurement system, and new measurement results data may be displayed in a graphical user interface for the second measurement system. Thus, a user may compare the original measurement to the subsequent (repeated) measurement. For example, the file may include raw measurement data from the measurement, and the repeated measurement may generate new raw data, and the method may include comparing the raw data from the measurement with the new raw data, and indicating any differences between the raw data from the measurement and the new raw data.

Similarly, in embodiments where the file further includes user annotations regarding the measurement, the method may include displaying at least a portion of the user annotations on a display device. In this manner, the user may gain improved understanding regarding any special or subtle aspects of the original measurement that a) might explain the above differences in raw data between the measurement and the new (repeated) measurement, or b) may help the user more accurately repeat the measurement. As explained above in detail, in various embodiments, the file may include any of various other items, including, for example, user identification, date and time of the measurement, ambient conditions of the measurement, an image of a physical setup of the first measurement system, at least one schematic simulation probe location, or multi-instrument probe locations (e.g., in some cases where the one or more instruments include a plurality of instruments), among others, as desired.

Thus, embodiments of a file generated based on a measurement by a first measurement system may include measurement data or information that may be used to automatically configure one or more instruments of a second measurement system to repeat the measurement. Moreover, in various further embodiments, the file may include various additional data or information that may further facilitate repetition or reproduction of the measurement, and/or may help the user understand any differences between the two measurements.

In one embodiment, the file may be used to generate a program to perform the automatic configuring of the one or more instruments. More specifically, the method may further include automatically generating a measurement application program based on the measurement configuration data. The measurement application program may then be executable by a computer system to configure the second measurement system or a third measurement system, i.e., to repeat or replicate the measurement. Once the measurement application program is generated, it may be used to automatically configure sufficiently similar measurement systems to repeat the measurement. Thus, the generated program may be sent or deployed over a network, e.g., the Internet, thereby facilitating reliable repetition or replication of measurements by other users (or may be used by the original user to easily repeat the measurement). Note, however, that due to the utility and possible benefits of the additional data or information that may be included in the file, the file may be stored or sent with the automatically generated program. Alternatively, the file may be sent or retrieved over a network, and the program generated as needed.

In some embodiments, the automatically generated program may be a graphical program, e.g., a graphical data flow program, such as a LabVIEW graphical program, although any other types of programs are also contemplated.

Thus, various embodiments of the techniques disclosed herein may allow users to select measurement data, and the configuration used to produce the measurement data may be automatically restored or replicated, thereby providing a seamless, more accurate, and simpler solution to measurement replication. More specifically, restoring settings based on the annotated measurement results image data may obviate many documentation/configuration steps that engineers would otherwise have to complete manually.

It should be noted that any of the features and limitations regarding the file, its generation, or its use, may be used in any combinations as desired.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A non-transitory computer accessible memory medium that stores program instructions executable by a processor to implement:
receiving measurement results from a first measurement system in response to a measurement by the first measurement system, wherein the first measurement system comprises one or more instruments;
displaying measurement results data via a display device in response to the received measurement results; and
storing a file, wherein the file comprises:
image data, wherein the image data are sufficient for display of the measurement results data by an image viewer; and
measurement configuration data, wherein the measurement configuration data are sufficient for configuring a second measurement system to repeat the measurement, wherein the second measurement system comprises the first measurement system or another instance of the first measurement system.

2. The non-transitory computer accessible memory medium of claim 1, wherein the measurement configuration data comprises:
instrument configuration data for the one or more instruments of the first measurement system, wherein the instrument configuration data are sufficient to configure the one or more instruments of the first measurement system or a corresponding one or more instruments of the second measurement system to repeat the measurement.

3. The non-transitory computer accessible memory medium of claim 2, wherein the instrument configuration data comprise one or more of:
an instrument device identification; or
a DUT (Device Under Test) version.

4. The non-transitory computer accessible memory medium of claim 2, wherein the first measurement system comprises a graphical user interface (GUI), and wherein the measurement configuration data comprises layout information useable to configure the GUI or a GUI of the second measurement system.

5. The non-transitory computer accessible memory medium of claim 2, wherein the one or more instruments comprise a multi-function instrument.

6. The non-transitory computer accessible memory medium of claim 5, wherein the multi-function instrument has an associated multi-instrument GUI for the multi-function instrument, wherein the measurement configuration data comprises layout information useable to configure the multi-instrument GUI, or a multi-instrument GUI of the second measurement system.

7. The non-transitory computer accessible memory medium of claim 2, wherein the one or more instruments comprise a plurality of instruments.

8. The non-transitory computer accessible memory medium of claim 7, wherein the plurality of instruments have an associated multi-instrument GUI for the plurality of instruments, wherein the measurement configuration data comprises layout information useable to configure the multi-instrument GUI, or a multi-instrument GUI of the second measurement system.

9. The non-transitory computer accessible memory medium of claim 1, wherein said receiving measurement results from the measurement system comprises receiving raw measurement data from the measurement system, wherein the file further comprises at least a portion of the raw measurement data.

10. The non-transitory computer accessible memory medium of claim 1, wherein the file further comprises user annotations regarding the measurement.

11. The non-transitory computer accessible memory medium of claim 1, wherein the file further comprises one or more of:
user identification; or
date and time of the measurement.

12. The non-transitory computer accessible memory medium of claim 1, wherein the file further comprises ambient conditions of the measurement.

13. The non-transitory computer accessible memory medium of claim 1, wherein the file further comprises:
an image of a physical setup of the measurement system.

14. The non-transitory computer accessible memory medium of claim 1, wherein the file further comprises:
at least one schematic simulation probe location.

15. The non-transitory computer accessible memory medium of claim 14, wherein the one or more instruments comprise a plurality of instruments, wherein the file further comprises:
multi-instrument probe locations.

16. The non-transitory computer accessible memory medium of claim 1, wherein the program instructions are further executable by a processor to implement:
displaying an image in a GUI based on the image data;
receiving user input to the GUI invoking display of the measurement configuration data; and
displaying the measurement configuration data in response to the user input to the GUI.

17. The non-transitory computer accessible memory medium of claim 16,
wherein the image comprises a screenshot of the measurement results data.

18. The non-transitory computer accessible memory medium of claim 16,
wherein said receiving user input to the GUI comprises receiving user input flipping the image; and
wherein said displaying the measurement configuration data comprises displaying the measurement configuration data in a manner suggestive that the measurement configuration data are displayed on the back of the image.

19. The non-transitory computer accessible memory medium of claim 1,
wherein the file is useable to automatically generate a measurement application program executable by a computer system to configure the first measurement system or another instance of the first measurement system.

20. The non-transitory computer accessible memory medium of claim 1,
wherein the measurement application program comprises a graphical measurement application program.

21. A computer implemented method, comprising:
utilizing a computer to perform:
performing a measurement via a measurement system, wherein said performing the measurement generates measurement results;
displaying measurement results data via a display device in response to the measurement; and
storing a file, wherein the file comprises:
image data, wherein the image data are sufficient for display of the measurement results data by an image viewer; and
measurement configuration data, wherein the measurement configuration data are sufficient for configuring a second measurement system to repeat the measurement, wherein the second measurement system comprises the first measurement system or another instance of the first measurement system.

22. The computer implemented method of claim 21, wherein the measurement configuration data comprises:
instrument configuration data for the one or more instruments of the first measurement system, wherein the instrument configuration data are sufficient to configure the one or more instruments of the first measurement system or a corresponding one or more instruments of the second measurement system to repeat the measurement.

23. The computer implemented method of claim 21, wherein said receiving measurement results from the measurement system comprises receiving raw measurement data from the measurement system, wherein the file further comprises at least a portion of the raw measurement data.

24. The computer implemented method of claim 21,
wherein the file is useable to automatically generate a measurement application program executable by a computer system to configure the first measurement system or another instance of the first measurement system.
